(19) United States
(12) Patent Application Publication
(10) Pub. No.: US 2013/0104691 A1
(43) Pub. Date: May 2, 2013

(54) ERGONOMIC HANDGRIP FOR A MOVEABLE APPARATUS

(71) Applicants: Jonathan Basch CHESNER, Santa Monica, CA (US); Charles Joseph Pulford, JR., Redondo Beach, CA (US)

(72) Inventors: Jonathan Basch CHESNER, Santa Monica, CA (US); Charles Joseph Pulford, JR., Redondo Beach, CA (US)

(21) Appl. No.: 13/448,380

(22) Filed: Apr. 16, 2012

Related U.S. Application Data
(60) Provisional application No. 61/552,448, filed on Oct. 27, 2011.

(51) Int. Cl. B62K 21/26

(52) U.S. Cl. 74/551.9

(57) ABSTRACT

Ergonomic handgrip that enables comfortable manipulation of a moveable apparatus such as a cart, sled, or wheelchair without affecting the portability or compactness of the folding capability of the moveable apparatus. Enables users of wheelchairs to adjust their body positioning by wrapping one or both arms around the handles of a wheelchair. Improves the comfort and manipulative ability of the person moving the apparatus by providing an improved grip that enables the hands of the person to be used in a natural, untwisted and relaxed overhand position.

This application claims the benefit of U.S. Provisional Patent Application Ser. No. 61/552,448 filed 27 Oct. 2011, the specification of which is hereby incorporated herein by reference.

### BACKGROUND OF THE INVENTION

1. Field of the Invention

One or more embodiments of the invention are related to the field of handgrips. More particularly, but not by way of limitation, one or more embodiments of the invention enable an ergonomic handgrip for a moveable device, such as wheeled devices, sleds, or other apparatus that may be moved by hand, such as a wheelchair for example.

2. Description of the Related Art

Due to accident, illness, or other circumstances, many individuals are unable to walk under their own power or do so with incredible difficulty. As a response, wheelchairs were invented long ago to provide mobility for an occupant either under their own power or with the aid of an assistant.

Historically, these wheelchairs were created out of wood. For more than half a century, the standard wheelchair has been crafted with metal tubing in a form that is similar to most chairs found today. Over the past century, several advancements have been made to the metal tubing design. Multiple improvements have been designed to aid the occupant to be more mobile under their own power. The improved mobility is a result of the wheel chair design that enables the occupant to better utilize his or her own strength or through use of a motor.

Advancement in the field to better aid the assistant has primarily focused on increasing the comfort for the assistant in their manipulation and control of the wheelchair. To this end, various devices have been implemented in an attempt to improve this aspect. For example, improvements in materials and construction methods have also led to advancements in the portability and compactness of modern wheelchairs. To various degrees inventors have attempted to improve control and maneuverability. However, such attempts have come at the expense of compactness or portability. In summary, these designs have failed to increase utility in one manner or another. For example, wheelchairs still utilize cylindrical handgrips which do not provide comfort for extend periods of time wherein the assistant has to rotate their hands downward and about a cylindrical grip. In addition, the cylindrical handgrips provide less than ideal control for the assistant, for example in humid or wet conditions or non-level surfaces.

For at least the limitations described above there is a need for an ergonomic handgrip for a moveable apparatus.

### BRIEF SUMMARY OF THE INVENTION

One or more embodiments described in the specification are related to an ergonomic handgrip for a moveable apparatus, such as a cart, sled, or wheelchair for example. An object of at least one embodiment of the invention is to provide an ergonomic adaptation, or alternative, to the traditional handgrip and associated method of pushing or handling an individual in a wheeled device, such as, but not limited to, a wheelchair or stroller. Traditionally, wheeled devices such as, but not limited to wheelchairs or strollers, have been conventionally manipulated by handgrips mounted on ‘canes’, which are generally cylindrically shaped tubes that function as mounts for the handgrips. The canes further interface with the moveable apparatus to transfer force applied to the handgrips to the moveable apparatus, for example to control and otherwise manipulate the moveable apparatus. The canes so utilized are generally either perpendicular (such as those on a wheelchair) or curved, and practically upright (such as those on a stroller). Although functional and easy to manufacture, the traditional cane type of device lacks ergonomic comfort and control. Embodiments of the ergonomic handgrip detailed herein are shaped to allow the hands to be used in multiple configurations, most notably a natural, untwisted, and relaxed “overhand” position that increases comfort and control, as opposed to the current “underhand” posture of traditional wheelchair canes.

Another object is to provide an ergonomic handgrip for moveable devices, such as handcarts or dollies, which minimizes or eliminates fatigue, discomfort, and pain even after prolonged effort or continued and repetitive use.

Another object is the increased amount of control from the addition of these grips that allows for superior manipulation of wheeled devices along an incline plane. Other objects and advantages will become apparent from a consideration of the drawings and ensuing description below.

Embodiments of the ergonomic handgrip generally include an ergonomic curved palm supporting surface configured to enable placement of an assistant's hand in order to support the hand in a more natural, untwisted position. This structure minimizes or altogether eliminates fatigue and discomfort for the assistant, even after prolonged or repetitive use. Embodiments of the invention may also include a “hooked” fingertip surface on either end or both ends of the curved palm supporting surface to increase control, for example to enable better downhill speed mitigation. One or more embodiments of the invention enable a simple and secure attachment mechanism that enables easy placement and removal of the ergonomic handgrip. One or more embodiments of the invention may be constructed from or otherwise utilize a highly durable epoxy composite, or any other material depending on the intended environment or application as desired.

One advantage of one or more embodiments of the invention is that the structure does not require the assistant to force his or her hand, wrist, and forearm to be twisted 45-60 degrees downwardly, out of the natural and relaxed position, or require constant muscular force to be applied by the hand, wrist, and forearm to maintain their positions.

Another advantage of one or more embodiments of the invention is that the structure eliminates the discomfort that a traditional assistant (handler, operator, caregiver, delivery man, or utility worker, etc.) of wheeled devices experiences over a prolonged and continuous period of use. Such discomfort includes fatigue and/or pain in the shoulders, neck, back, wrists, hands, and forearms.

Another advantage of one or more embodiments of the invention is the structure supports the assistant's hands in the most natural and relaxed position for upright walking. Thus the structure acts much like an extension of the assistant's arm. The fingers rest over the top of the grip, simply pronated rather than having an underhanded posture, allowing for a much easier manipulation of the wheeled device along any kind of incline. In one or more embodiments, the assistant's hand are in line with the assistant's forearms for example in a completely relaxed position.

Another advantage of one or more embodiments of the invention is that the structure greatly increases control for reverse motion of the wheeled device. In this scenario, the structure enables the assistant to utilize an underhand posture, on the bottom of the underside of the grip. This increases leverage and lifting capability, whilst enabling the assistant to maintain a firm and secure hold on the handgrip.

Another advantage of one or more embodiments of the invention is that the structure enables far better control or speed mitigation on a downhill incline. In this scenario, the structure enables the assistant to utilize an overhand posture, on the top of the underside of the handgrip. This increases manipulative ability and overall control while maintaining a firm and secure hold on the grip itself. In addition, use of embodiments of the invention with an overhand position allows the assistant to press the back of the moveable apparatus down easier than with traditional grips, for example to raise the front end over ledges, curbs, etc.

Another advantage of one or more embodiments of the invention is that the structure enables easy placement and removal of the individual grips. When the grips are configured as non-permanent additions, in one or more embodiments, a simple hex driver can be used to undo the anchoring setscrews, releasing the grips. This type of coupling to the wheeled device does not hinder the structures form or capabilities. In this scenario, embodiments of the invention can be removed and stored for future need or for traveling purposes for example. In embodiments of the invention that are permanently affixed to the wheeled device, the structure only adds an extra dimension of a few inches and a negligible weight increase.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a side view of an embodiment of the ergonomic handgrip disconnected from a wheelchair cane handle.

FIG. 2 illustrates a semi-isometric view of an embodiment of the ergonomic handgrip with an assistant's right hand shown, when not attached to a wheelchair handle.

FIG. 3 illustrates a right side an embodiment of the ergonomic handgrip mounted on the cane of a wheelchair.

FIG. 4 illustrates a right side view of a traditional grip mounted on the cane of a wheelchair.

FIG. 5 illustrates an inward right side view of a right hand and how one holds a traditional molded grip with “underhand” positioning, which requires the assistant to use force to grip in the handle in a downward manner that is unnatural and which causes fatigue and decreases control.

FIG. 6 illustrates a cutaway three-quarter view an embodiment of the invention along with a right hand of an assistant wherein the structure of one or more embodiments of the invention enables the assistant to the handgrip in a secure and fatigue free manner while propelling a wheelchair in a forward motion (see also FIG. 13 for a closeup).

FIG. 7 illustrates a left side view of a right hand and how an assistant can hold an embodiment of the ergonomic handgrip using an overhand position to mitigate speed, move backwards, or increase control on a steep incline.

FIG. 8 illustrates a left side view of a right hand and how one can hold an embodiment of the ergonomic wheelchair handgrip using an underhand position to mitigate speed, move backwards, or increase control on a steep incline.

FIG. 9 illustrates a posterior view of an embodiment of the ergonomic handgrip with placement of base plate and sleeve shown.

FIG. 10 illustrates a side view of the ergonomic handgrip affixed to wheelchair cane using setscrews.

FIG. 11 illustrates a semi-isometric view of the ergonomic handgrip shown with the left hand of an assistant, when not attached to a wheelchair handle.

FIG. 12 illustrates a right side view of the ergonomic handgrip held in an overhand posture with the right hand with mounting plate and sleeve as shown.

FIG. 13 illustrates a posterior isometric view of the ergonomic handgrip held in an overhand posture (see also FIG. 6 for a view with the wheelchair), along with various additional accessories.

FIG. 14 illustrates a side view of the ergonomic handgrip with an internal cut-away showing the expanding anchor mechanism in accordance with an alternative embodiment of the invention.

### DETAILED DESCRIPTION

An ergonomic handgrip for a moveable apparatus will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

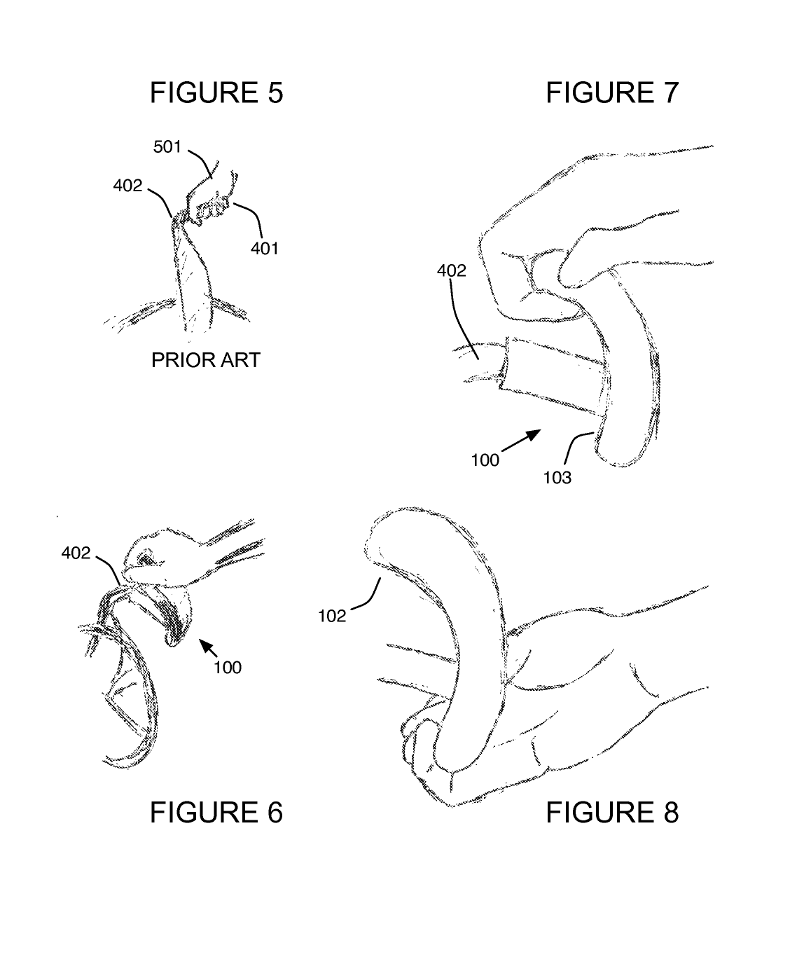

FIG. 4 illustrates a right side view of traditional grip 401 mounted on cane 402 of wheelchair 403. Traditional handgrips are often composed of plastic or foam that is secured over the metal tube that extends from the back of the chair. FIG. 5 illustrates an inward right side view of a right hand 501 of an assistant to show how the assistant holds a traditional molded grip with “underhand” positioning. Traditional wheelchair handgrips, such as handgrip 401, require an assistant to utilize a rotated underhand grip, with palms facing inward towards each other.

FIG. 6 illustrates a cutaway three-quarter view an embodiment of the invention along with a right hand of an assistant wherein the structure of one or more embodiments of the invention enables the assistant to the handgrip in a secure and fatigue free manner while propelling a wheelchair in a forward motion. This is in opposition to known handgrips that require the assistant's hand to be rotated at a 45-90 degree angle as shown in FIG. 5. Hence, embodiments of the invention enable the assistant's hand to interface with the structure in a more comfortable, natural, and un-rotated position as shown in FIG. 7 as well. As shown, embodiments of the invention 100 enable an assistant's hand to engage the structure in a much more comfortable and secure manner, including but not limited to humid or wet environments. The hand, wrist, and elbow are able to relax in this position. The inward slope of the sides of the grip as shown enable a combination of fingers to wrap around the grip to improve control. The palm and fingers can rest anywhere along the rounded outer shell of handgrip 100. The structure enables the assistant's fingers to wrap over the side edges of the grip to increase comfort and grip as well.

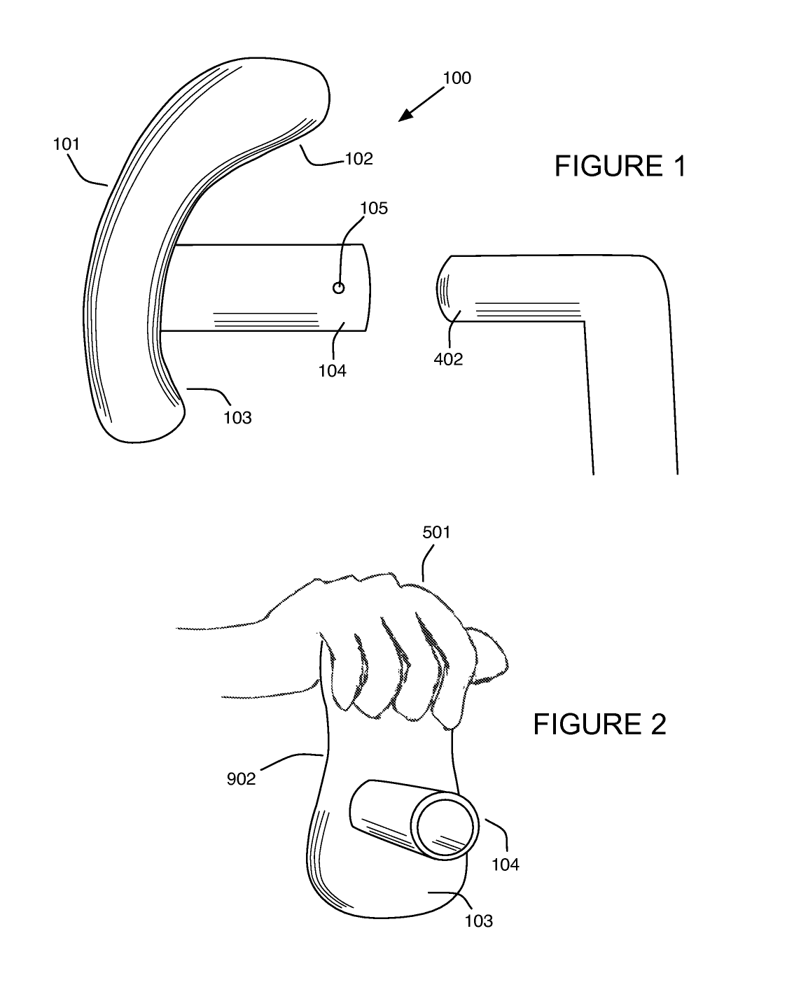

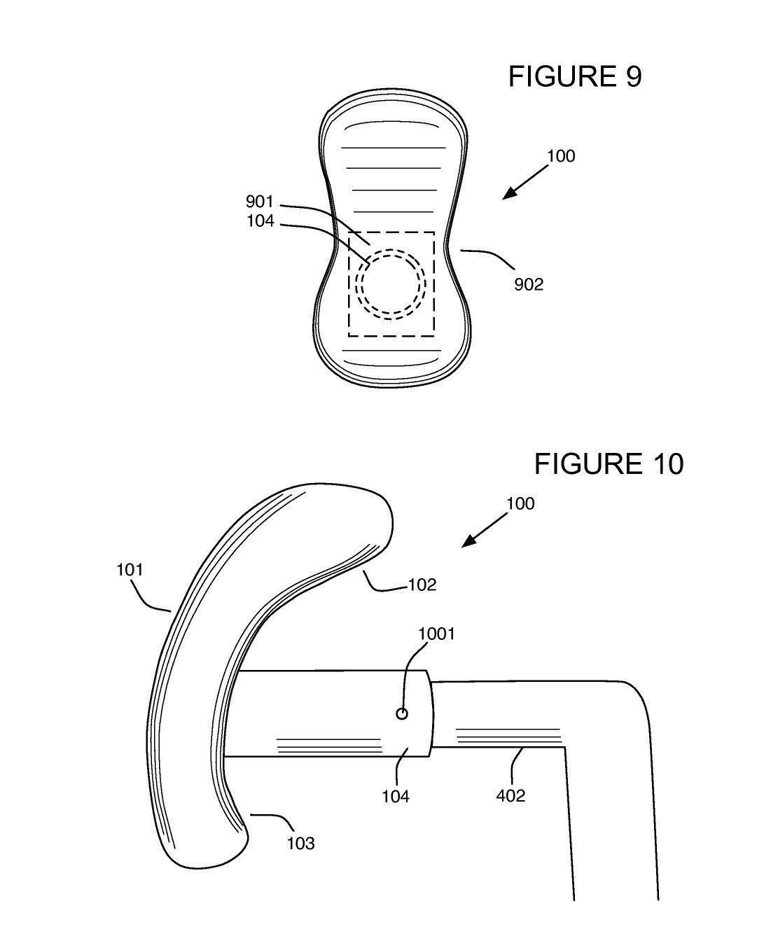

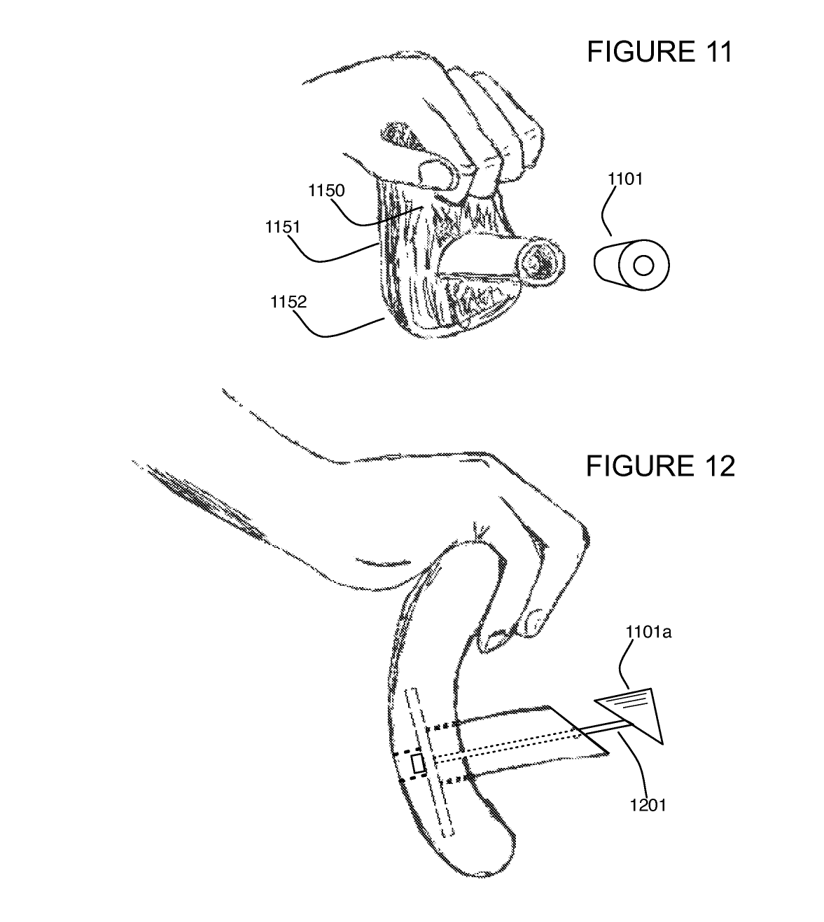

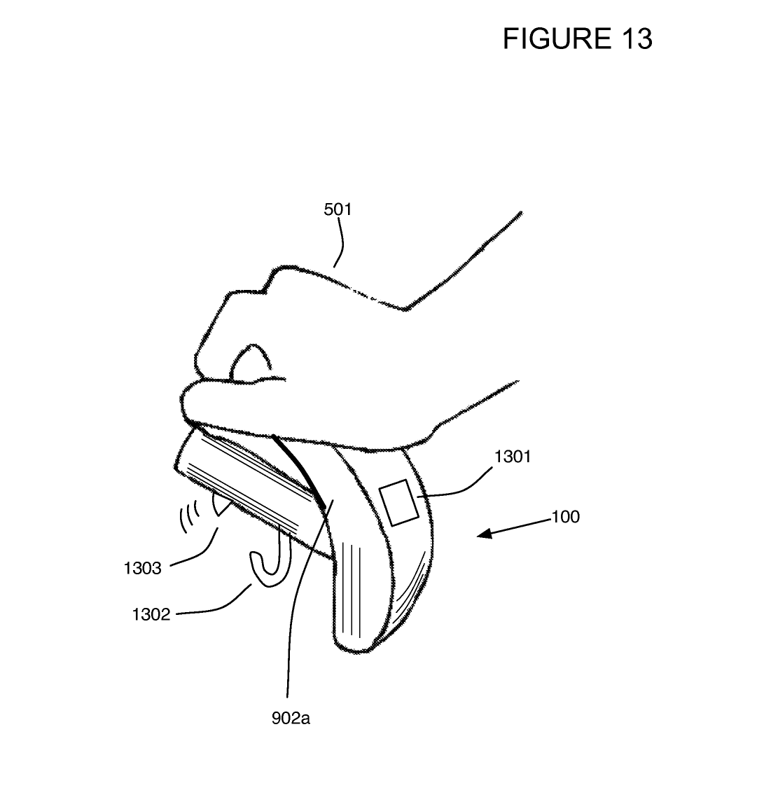

FIG. 1 illustrates a side view of an embodiment of ergonomic handgrip 100 disconnected from wheelchair cane handle 402. As shown, outer curved portion 101 is configured to enable an assistant's palm or metacarpus to engage the structure in a neutral non-fatiguing manner. Top inwardly curved portion 102 is configured to enable an assistant's fingers to hook or otherwise engage the structure from above. Bottom inwardly curved portion 103 is configured to enable an assistant's fingers to hook or otherwise engage the structure from below. In one or more embodiments of the invention, ergonomic handgrip 100 couples with or encompasses a pre-existing portion of the wheeled device, for example the pre-existing metal tube or cane 402. One or more embodiments may optionally utilize sleeve 104 for example to couple with cane 402. See FIGS. 12 and 15 for a sleeveless embodiment. Sleeve 104 may be implemented as a cylinder or any other structure that is capable of coupling with a wheel device. Anchoring element 105 may be implemented with any structure that can couple sleeve 104 with the wheeled device, for example through use of a permanent or non-permanent coupling element of any type as desired. Although the term sleeve is utilized herein to refer to the element of the structure that couples with the wheeled device, the sleeve is not limited to a cylinder shape and any other shape that can couple with a wheeled device may be utilized in one or more embodiments of the invention. In one or more embodiments sleeve 104 is coupled over the outer diameter of cane 402, although partial enclosure or internal engagement may also be utilized. In these embodiments, the inner diameter of sleeve 104 is greater than the outer diameter of cane 402, although embodiments that may stretch may have an internal diameter that is less than the outer diameter of the cane for example. Hard rubber embodiments that may be slipped on with a temporary lubricant are in keeping with the spirit of the invention for example. In one or more embodiments, anchoring element 105 may be a setscrew or spring loaded pushpin for example in non-permanent mounting embodiments. An internal anchor, twist lock, screw on mechanism or any other coupling mechanism may also be utilized. In one or more embodiments of the invention the top and bottom portions 102 and 103 may be thicker (extending normal to the written page) than the middle portion near the sleeve (see side portion 902 in FIGS. 2 and 9). The degree of curvature of curved portion 101 may or may not be equal for the top and bottom portions and may also not be equal with respect to the thickness (normal to the written page). In one or more embodiments, the arc of the top and bottom portions may extend forward of the mount point of sleeve 104 to facilitate placement of an assistant's fingers and/or may extend in any shape or manner as desired, for example for ease of manufacture. In one or more embodiments, the length of handgrip 100 extending above and below the intersection point of the sleeve may be unequal, for example top inwardly curved portion 102 may extend further above sleeve 104 than bottom inwardly curved portion 103 extends below sleeve 104. In one or more embodiments, there are no sharp edges or planar edges on the surface of handgrip 100, although this is not required. In one or more embodiments of the invention, handgrip 100 may be implemented with plastic that contains a surface area that is not flat, for increased coefficient of static friction. Any known material, with any surface structure or texture may be utilized in the construction of handgrip 100, including but not limited to metal, plastic, rubber, carbon fiber, wood or any other material. The surface structure may be macro sized, for example a knurled or patterned surface or coating thereof, or may utilize any nanotechnology micro sized structure or coating. For example, the texture of handgrip 100 may include a structure or coatings that are indented or outward pointing structures or both. Example textures that may be employed include spider web patterns, materials with uneven surfaces such as neoprene, rubber, sponge rubber, thermo molding rubber, cork, mesh, waffle or grid patterns. Materials that change color based on temperature may also be utilized. In addition, one or more embodiments of the invention may include light reflective areas, logos, thumbholes, finger grooves. One or more embodiments of the invention may utilize nanocrystalline structures for example to increase grip and/or increase roll off effect of water. These structures include Gecko based nanotechnology for grip and lotus effect structures for water reducing and self-cleaning elements. Embodiments of the invention may also be utilized with walker-devices or upright canes, industrial handcarts and dollies, and parent-driven strollers. Also, see also FIG. 10 for a mounted view of an embodiment of the invention. One or more embodiments of the invention may be constructed with a height of curved surface 101 of 4.5″ (extending up from the bottom to top of curved area), with a center width (see FIG. 2 902) of 2.5″ and width at the top and bottom 102 and 103 of 3″ (horizontal axis in FIG. 2), with a depth of the top portion of 1.5″ (extending horizontally in FIG. 1) and depth of the bottom portion of 1″. The depth of the arc at the top portion may be 1.5″ at 102 and 0.5″ at 103 for example. Any other curved or non-non-horizontal cylinder dimensions are in keeping with the spirit of the invention and the dimensions described herein are exemplary in nature only and not required. The sides of handgrip 100 may be rounded as well for comfort. See also FIG. 13 for other attachments, elements and features.

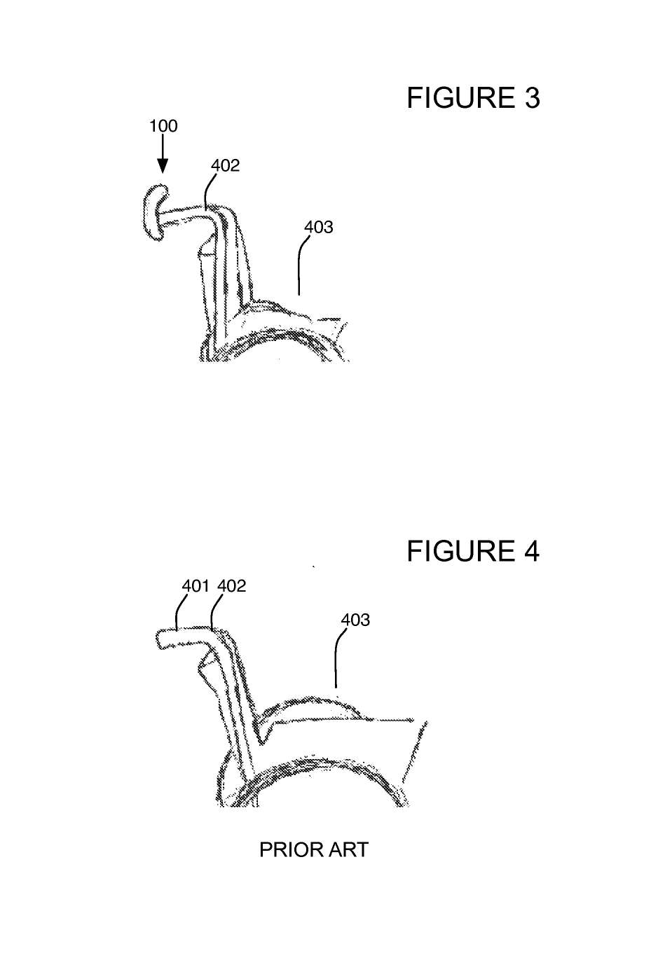

FIG. 2 illustrates a semi-isometric view of an embodiment of ergonomic handgrip 100 with assistant's right hand 501 shown, when handgrip 100 is not attached to a wheelchair handle for example. FIG. 3 illustrates a right side an embodiment of ergonomic handgrip 100 mounted on cane 402 of wheelchair 403. Ergonomic handgrip 100 can be manipulated both in an overhand manner as also shown in FIG. 7 and in an underhand manner as shown in FIG. 8. Hence, the structure of handgrip 100 enables the assistant's hands to engage the structure in either overhand or underhand position, and thus increased control and support is created especially on inclines, greatly increasing maneuverability and speed mitigation. More specifically, handgrip 100 enables assistant's hands to remain in a relaxed and more natural pronated position, eliminating substantial twisting of the hand, wrist, and forearm that are common to users of conventional molded grips. By enabling an open palm to be utilized, weight is freely distributed along a greater surface area, greatly reducing the strain on the wrist and forearm with respect to conventional molded grips, and to which their positioning can cause. As a result, fatigue, discomfort, and pain, are minimized or eliminated by handgrip 100 even after extended periods of use. Middle portion 902 may or may not be narrower or wider than the top and bottom portions as desired.

FIG. 7 illustrates a left side view of a right hand and how an assistant can hold an embodiment of the ergonomic handgrip using an overhand position to mitigate speed, move backwards, or increase control on a steep incline.

FIG. 8 illustrates a left side view of a right hand and how one can hold an embodiment of the ergonomic wheelchair handgrip using an underhand position to mitigate speed, move backwards, or increase control on a steep incline.

FIG. 9 illustrates a posterior view of an embodiment of the ergonomic handgrip with placement of base plate 901 for example within handgrip 100 and optional sleeve 104 shown. Base plate 901 is not required to be flat, and any other shape or structure may be utilized including a integral sleeve that is formed in one structure with handgrip 100. Alternatively, the sleeve may be eliminated and a bolt through a hole in the grip may be utilized to pull the cane and grip together against base plate 901. In other embodiments, a sleeve may be eliminated and replaced with a cylinder that fits inside of the cane, see FIG. 12. Base plate 901 may also be implemented in a shape that is higher as shown to provide more mechanical support for the top portion of handgrip 100. Handgrip 100 may have an hourglass shape for example as side portion 902 may be narrower than the top and bottom portions of handgrip 100, or alternatively may employ vertical sides wherein side portion 902 is not narrower than the top of bottom or is the average size of the top and bottom, or is wider than the top or bottom if desired and which is not shown for brevity as one skilled in the art will appreciate.

FIG. 10 illustrates a side view of the ergonomic handgrip affixed to wheelchair cane using setscrew 1001 for example. Any other type or number of coupling elements may be utilized in place of setscrew 1001 depending on the intended application or environment for which the device is to be utilized. For example, the sleeve may include threads and thread onto the cane, adhesives may be utilized for example to epoxy the sleeve to the cane, the sleeve may be welded to the cane, one way ratcheting teeth may be utilized inside the sleeve for quick permanent installation or expanding anchors may be utilized as well. Any other coupling element may be utilized as desired for the particular application as one skilled in the art will appreciate. Again, the sleeve may be eliminated in one or more embodiments that screw or bolt the grip to the cane, for example against one or more washers or one or more base plates on or in the grip.

FIG. 11 illustrates a semi-isometric view of ergonomic handgrip 100 shown with the left hand of an assistant, when not attached to a wheelchair handle. In addition, in one or more embodiments of the invention a conical coupling element may be utilized to engage the inner portion of a tubular cane element. In this embodiment, conical coupling element 1101 may include a threaded hole to enable a bolt or screw element, for example that extends into a hole handgrip 100, to engage the conical coupling element and pull the element towards the grip which widens the end of the sleeve to engage the inner portion of the cane. FIG. 12 illustrates a right side view of the ergonomic handgrip held in an overhand posture with the right hand with mounting plate and internal cylinder or bicycle style mount as shown. In addition, screw 1201 is shown engaging slanted coupling element 1101 a that is configured to engage the inner portion of the cane. Note that this embodiment does not utilize a sleeve and in addition, does not require an internal cylinder and slanted coupling element, for example for canes that are threaded or include a nut or other coupling element within the cane that enables the grip to be bolted or screwed onto the cane in any manner as one skilled in the art will appreciate.

FIG. 13 illustrates a posterior isometric view of the ergonomic handgrip held in an overhand posture. In addition, screw hole 1301 is also shown which enables the coupling of handgrip 100 to the wheeled device. Element 1301 may be implemented as a hidden compartment to hide keys, money, etc., and or may be implemented as a light switch for light 1303 for example. Electrical element 1301 may be implemented as an electronics package, for example a GPS device, pedometer, accelerometer, thermometer, speakers, music player, communications device, light or switch for light 1303 or any combination thereof. Accessory coupling element or loop 1302 may be any hook or connective element such as a carabiner for example configured to hold keys or a keychain or an umbrella or umbrella holster, pouch, bag, purse, cell phone pouch, gloves, or any other item.

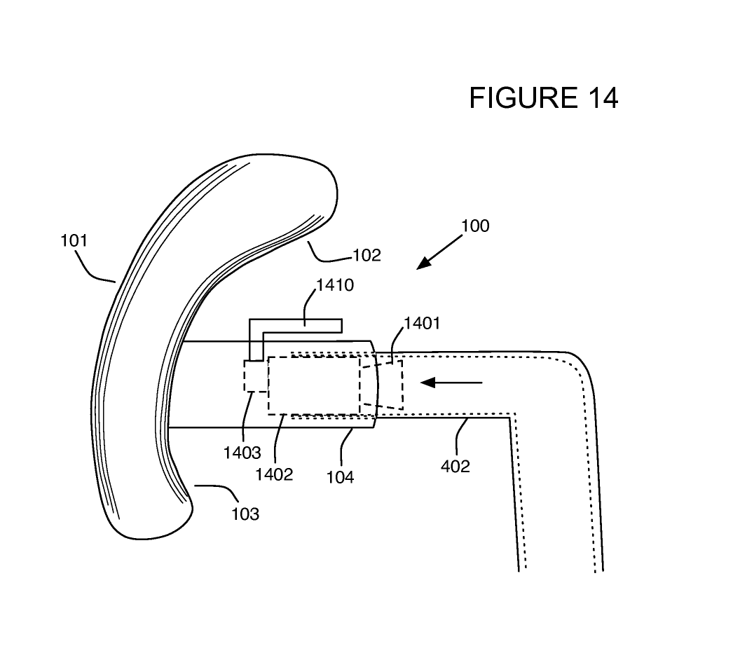

FIG. 14 illustrates a side view of the ergonomic handgrip with an internal cut-away showing the expanding anchor mechanism in accordance with an alternative embodiment of the invention. As shown, teeth 1401 are pulled into enclosing element 1402 by mechanism 1403 that rotates via Allen wrench 1410 and draws teeth 1401 into enclosing element 1402, which expands the end of enclosing element 1402 to engage the outer cane.

Several embodiments of the front and side silhouettes of the ergonomic handgrip may have an outer curved portion which represent figure eight, semi-oval, faceted semi-oval, elliptical and rectangular embodiments. Each embodiment is configured with coupling element hole or fastener hole, for example that may be utilized to house a coupling element such as a screw that couples with an mounting element inside the apparatus to be coupled with, for example a bicycle type coupling element as commonly found on a bicycle neck to hold the handle bars to the front axle. See also FIGS. 9, 12 and 14 for embodiments that couple with or without a sleeve for example using a screw such as screw 1201 shown in FIG. 12. Any other shape that includes a substantially flat or curved surface that intersects the axis of the canes to be coupled with at a non-zero angle may be utilized in keeping with the spirit of the invention, so long as the embodiment has more area than the end plate of a standard cylinder handle, which is less than 1 inch in area in a circle for example. In these and/or other embodiments any shape other than a cylinder parallel to the cane may be utilized, and in these and/or other embodiments any shape that is configured to enable an assistant's palm or metacarpus to engage the structure in a neutral non-fatiguing manner may be utilized in keeping with the spirit of the invention. Top inwardly curved portions are configured to enable an assistant's fingers to hook or otherwise engage the structure from above. These embodiments may curve downwardly with respect to the uppermost point, or may curve in the rearward direction as well or may also curve rearward and upward. Although the embodiments are curving away at the top and bottom of the elements, the curves may also be on the sides with slight curve on the portions where the hand is engaged of each embodiment, wherein hard edges are minimized or avoided to provide comfort as desired. Bottom inwardly curved portions may be inwardly curved with respect to the bottom, i.e., simply curve upward, or may also curve in a rearward direction, or may curve in a rearward and then downward direction. Any of the embodiments may utilized faceted areas with facets on the two sides, or may utilize rounded edges in any portion or area. Texture may be any macro or micro texture, such as but not limited to spider web, hatching, knurling, dots, nanostructures or any other texture listed herein or any other texture desired.

While the invention herein disclosed has been described by means of specific embodiments and applications thereof, numerous modifications and variations could be made thereto by those skilled in the art without departing from the scope of the invention set forth in the claims.

What is claimed is:

1. An ergonomic handgrip for a moveable wheeled apparatus comprising:
a non-cylindrical grip having an outer curved portion comprising a curved surface having an area greater than an area at an end of a cylinder to which the non-cylindrical grip couples, which is configured to engage a palm of a hand of an assistant comprising
a top inwardly convex curved portion situated on a top opposing side of said curved surface configured to engage the palm of the hand of the assistant, wherein said top inwardly curved portion curves in a first direction, and curves back in a second direction different from said first direction, and wherein said top inwardly convex curved portion is further configured to enable fingers of the assistant to wrap around said top inwardly convex curved portion when said hand is placed over said non-cylindrical grip, and
a bottom inwardly convex curved portion situated on a bottom opposing side of said curved surface configured to engage the palm of the hand of the assistant, wherein said bottom inwardly curved portion curves in a first direction and curves back in a second direction, and wherein said bottom inwardly convex curved portion is further configured to enable fingers of the assistant to wrap around said bottom inwardly convex curved portion when said hand is placed under said non-cylindrical grip;
a middle inwardly convex curved portion situated between said top inwardly convex curved portion and said bottom inwardly convex curved portion;
a mounting element;
a mounting plate with a substantially flat portion coupled to said mounting element and said non-cylindrical grip;
a coupling element configured to couple with said mounting plate and couple said mounting plate with said moveable wheeled apparatus,
wherein said mounting plate is positioned orthogonally to said wheels of said moving apparatus, such that the substantially flat portion of said mounting plate intersects an axis of said wheels transversely to said non-cylindrical grip,
wherein said mounting plate is positioned in said middle inwardly curved portion,
wherein said top inwardly curved portion and said bottom inwardly curved portion are thicker than said middle inwardly curved portion where said mounting plate is positioned,
wherein said first direction of said top inwardly curved portion curves in a forward direction away from said mounting plate, and said second direction of said top inwardly curved portion curves in a direction towards said mounting plate thereby creating a top inwardly curved arc,
wherein said first direction of said bottom inwardly curved portion curves in a forward direction away from said mounting plate, and said second direction of said bottom inwardly curved portion curves in a direction towards said mounting late thereby creating a bottom inwardly curved arc, such that
said to inwardly curved arc and said bottom inwardly curved arc are configured to enable fingers of said assistant
to wrap around said top inwardly curved portion around said top inwardly curved arc in an overhand manner, and
to wrap around said bottom inwardly curved portion around said bottom inwardly curved arc in an underhand manner.

2. (canceled)

3. The ergonomic handgrip for a moveable wheeled apparatus of claim 1 wherein said coupling element is a threaded element and said mounting element is an element that moves or expands to couple with an inner portion of a cylinder when said screw is rotated.

4. The ergonomic handgrip for a moveable wheeled apparatus of claim 1 wherein said mounting element comprises an internal diameter less than a cylinder to which said mounting element is configured to couple with.

5. The ergonomic handgrip for a moveable wheeled apparatus of claim 1 wherein said mounting element comprises a material that stretches around said cylinder.

6. The ergonomic handgrip for a moveable wheeled apparatus of claim 1 wherein said coupling element is a permanent coupling element.

7. The ergonomic handgrip for a moveable wheeled apparatus of claim 1 wherein said coupling element is a non-permanent coupling element.

8. The ergonomic handgrip for a moveable wheeled apparatus of claim 1 wherein said coupling element is at least one setscrew and said mounting element is a sleeve.

9. The ergonomic handgrip for a moveable wheeled apparatus of claim 1 wherein said non-cylindrical grip further comprises a side portion having a smaller width than said top inwardly curved portion and said bottom inwardly curved portion.

10. The ergonomic handgrip for a moveable wheeled apparatus of claim 1 wherein said non-cylindrical grip further comprises a side portion having a larger width than said top inwardly curved portion and said bottom inwardly curved portion.

11. The ergonomic handgrip for a moveable wheeled apparatus of claim 1 wherein said non-cylindrical grip further comprises a coating that improves grip.

12. The ergonomic handgrip for a moveable wheeled apparatus of claim 1 wherein said non-cylindrical grip further comprises a macro surface structure that improves grip.

13. The ergonomic handgrip for a moveable wheeled apparatus of claim 1 wherein said non-cylindrical grip further comprises a nanotechnology coating that improves grip.

14. The ergonomic handgrip for a moveable wheeled apparatus of claim 1 wherein said non-cylindrical grip further comprises a nanotechnology coating that is self-cleaning.

15. The ergonomic handgrip for a moveable wheeled apparatus of claim 1 wherein said non-cylindrical grip further comprises a nanotechnology coating that enables water to roll off of said handgrip.

16. The ergonomic handgrip for a moveable wheeled apparatus of claim 1 wherein said non-cylindrical grip further comprises an accessory coupling element.

17. The ergonomic handgrip for a moveable wheeled apparatus of claim 1 wherein said non-cylindrical grip further comprises an electrical element or switch for an electrical element.

18. An ergonomic handgrip for a moveable wheeled apparatus comprising:
a non-cylindrical grip having an outer curved portion comprising a curved surface having an area greater than an area at an end of a cylinder to which the non-cylindrical grip couples, which is configured to engage a palm of a hand of an assistant comprising
a top inwardly convex curved portion situated on a top opposing side of said curved surface configured to engage the palm of the hand of the assistant, wherein said top inwardly curved portion curves in a first direction, and curves back in a section direction different from said first direction, and wherein said top inwardly convex curved portion is further configured to enable fingers of the assistant to wrap around said top inwardly convex curved portion when said hand is placed over said non-cylindrical grip, and
a bottom inwardly convex curved portion situated on a bottom opposing side of said curved surface configured to engage the palm of the hand of the assistant, wherein said bottom inwardly curved portion curves in a first direction, and curves back in a second direction, and wherein said bottom inwardly curved convex portion is further configured to enable fingers of the assistant to wrap around said bottom inwardly convex curved portion when said hand is placed under said non-cylindrical grip;
a middle inwardly convex curved portion situated between said top inwardly convex curved portion and said bottom inwardly convex curved portion;
a mounting element;
a mounting plate with a substantially flat portion coupled to said mounting element and said non-cylindrical grip;
a coupling element configured to couple with said mounting plate and couple said mounting plate with said moveable wheeled apparatus;
wherein said mounting plate is positioned orthogonally to said wheels of said moving apparatus, such that the substantially flat portion of said mounting plate intersects an axis of said wheels transversely to said non-cylindrical grip,
wherein said mounting plate is positioned in said middle inwardly curved portion,
wherein said top inwardly curved portion and said bottom inwardly curved portion are thicker than said middle inwardly curved portion where said mounting plate is positioned,
wherein said first direction of said top inwardly curved portion curves in a forward direction away from said mounting plate, and said second direction of said top inwardly curved portion curves in a direction towards said mounting plate thereby creating a top inwardly curved arc,
wherein said first direction of said bottom inwardly curved portion curves in a forward direction away from said mounting plate, and said second direction of said bottom inwardly curved portion curves in a direction towards said mounting late thereby creating a bottom inwardly curved arc, such that
said to inwardly curved arc and said bottom inwardly curved arc are configured to enable fingers of said assistant
to wrap around said top inwardly curved portion around said top inwardly curved arc in an overhand manner, and
to wrap around said bottom inwardly curved portion around said bottom inwardly curved arc in an underhand manner; and,
a coating or macro surface structure or nanotechnology coating coupled with said curved surface that improves grip.

19. The ergonomic handgrip for a moveable wheeled apparatus of claim 18 wherein said non-cylindrical grip further comprises an accessory coupling element.

20. The ergonomic handgrip for a moveable wheeled apparatus of claim 18 further comprising an electrical element or switch for an electrical element.
